(19) United States
(12) Patent Application Publication
(10) Pub. No.: US 2005/0059770 A1
(43) Pub. Date: Mar. 17, 2005

(54) Formaldehyde free insulation binder

(75) Inventors: Ramji Srinivasan, Duluth, GA (US); Cornel Hagiopol, Lilburn, GA (US); Natasha R. Bailey, Conyers, GA (US)

Correspondence Address: BANNER & WITCOFF, 1001 G STREET N W, SUITE 1100, WASHINGTON, DC, 20001, US

(73) Assignee: Georgia-Pacific Resins Corporation, Atlanta, GA (US)

(21) Appl. No.: 10/661,768

(22) Filed: Sep. 15, 2003

(51) Int. Cl. C08F 118/02; E04B 1/74; C08K 3/40

(52) U.S. Cl. 524/494; 252/62

(57) ABSTRACT

An aqueous binder composition containing a water-soluble and substantially infinitely water-dilutable free radical polymerized adduct of a monomeric carboxylic acid component and a monomeric hydroxyl component, polymerized in the presence of a chain transfer agent, and the related method of its use for making glass fiber products, especially fiberglass insulation.

### FIELD OF THE INVENTION

The present invention relates to a new formaldehyde-free binder composition, to the related method of its use for making fiberglass insulation and related fiberglass products (glass fiber products) and to the glass fiber products themselves. The present invention particularly relates to an aqueous binder composition containing a water-soluble and substantially infinitely water-dilutable, self-curable (i.e., thermosetting or thermosettable) adduct of an unsaturated carboxylic acid (—COOH) monomer and an unsaturated hydroxyl (—OH) monomer.

### BACKGROUND OF THE INVENTION

Phenol-formaldehyde (PF) resins, as well as PF resins extended with urea (PFU resins), have been the mainstays of fiberglass insulation binder technology over the past several years. Such resins are inexpensive and provide the cured fiberglass insulation product with excellent physical properties.

One of the drawbacks of this technology, however, is the potential for formaldehyde emissions during the preparation of the adhesive resin, during the manufacturing of the fiberglass insulation and during its subsequent use. Fiberglass insulation is typically made by spaying a dilute aqueous solution of the PF or PFU resin adhesive binder onto a moving mat or blanket of non-woven glass fibers, often hot from being recently formed, and then heating the mat or blanket to an elevated temperature in an oven to cure the adhesive resin. Manufacturing facilities using PF and PFU resins as the main adhesive binder component for insulation products recently have had to invest in pollution abatement equipment to minimize the possible exposure of workers to formaldehyde emissions and to meet Maximum Achievable Control Technology (MACT) requirement Standards.

As an alternative to PF and PFU resins, certain formaldehyde free formulations have been developed for use as an adhesive binder for making fiberglass insulation products. One of the challenges to developing suitable alternatives, however, is to identify formulations that have physical properties (viscosity, dilutability, etc.) and other characteristics similar to the standard PF and PFU resins, i.e., formulations which also have a similar cure time/cure temperature profile, while yielding a cured fiberglass insulation product with equivalent physical properties.

U.S. Pat. No. 5,030,507 describes an emulsion copolymer binder for nonwoven products that cures formaldehyde free. The copolymer is prepared by the emulsion polymerization of an (meth)acrylic acid ester, with styrene, acrylonitrile or vinyl acetate, with a hydroxy(meth)acrylate and with an isocyanate.

U.S. Pat. Nos. 5,198,492 and 5,278,222 describes a latex binder for cellulose, said to be especially useful where low formaldehyde emissions are important. The binder is a combination of a non-formaldehyde emitting latex admixed with an aqueous copolymer dispersion of a highly functionalized emulsion copolymer. The functionalized emulsion copolymer is a low solids emulsion, i.e., 10 to 16% by weight of solids, made from 10 to 60% of an olefinically unsaturated non-ionic organic compound and equal parts of a carboxylic acid and an olefinically unsaturated carboxylic acid hydroxy ester, or an olefinically unsaturated amide, or mixtures thereof.

U.S. Pat. No. 5,318,990 describes a formaldehyde free formulation for fiberglass insulation based on an aqueous solution of a polymeric carboxylic acid, such as a polyacrylic acid, and a triol, such as glycerol, trimethylolpropane and the like. Other polyols may optionally be present. The formulation relies on the presence of a phosphorus accelerator (catalyst) in the aqueous solution to obtain an effective cure at suitable temperatures.

U.S. Pat. No. 5,340,868 describes a binder for making a fiberglass mat comprising an aqueous solution of a polymeric carboxylic acid, such as polyacrylic acid, a β-hydroxyalkylamide and an at least tri-functional monomeric carboxylic acid, such as citric acid, trimellitic acid, hemimellitic acid, trimesic acid, tricarballylic acid, 1,2,3,4-butanetetracarboxylic acid (BTCA) and pyromellitic acid.

U.S. Pat. No. 5,354,803 describes a graft copolymer of polyvinyl alcohol (PVOH) as a formaldehyde-free binder, having a vinyl or acrylic monomer grafted onto the PVOH through emulsion polymerization in the presence of free-radical generators. Suitable monomers include acrylic acid and maleic acid.

U.S. Pat. No. 5,393,849 describes a curable composition useful in making binder formulations made by combining an unsaturated polyester resin and a polyamino compound.

U.S. Pat. No. 5,498,658 (and the related divisional U.S. Pat. No. 5,520,997) describes a self-curing, formaldehyde-free interpolymer latex binder. The interpolymer is prepared principally by emulsion polymerization from the following monomers (1) an unsaturated monomer having a nucleophile group, (2) an unsaturated dicarboxylic acid, (3) (meth)acrylonitrile and optionally (4) a (meth)acrylic acid ester and (5) styrene. As described, the unsaturated monomer having a nucleophile group has a functional group, such as an amino or hydroxyl, which in combination with the dicarboxylic acid, allows the polymer to self-cross-link. Examples of such monomers are acrylamide and hydroxpropyl acrylate (see Examples 1, 2 and 3). Representative dicarboxylic acids include maleic acid and itaconic acid.

U.S. Pat. No. 5,661,213 describes a formaldehyde free formulation for fiberglass insulation based on an aqueous solution of a polyacid, such as a polyacrylic acid, and a polyol (at least a diol), with a molecular weight less than about 1000, such as, for example, ethylene glycol, glycerol, pentaerythritol, trimethylol propane, sorbitol, sucrose, glucose, resorcinol, catechol, pyrogallol, glycollated ureas, 1,4-cyclohexane diol, diethanolamine, triethanolamine, and certain reactive polyols such as, for example, β-hydroxyalkylamides. The formulation relies on the presence of a phosphorus accelerator (catalyst) in the aqueous solution to obtain an effective cure at suitable temperatures.

U.S. Pat. No. 5,932,689 describes a formaldehyde free formulation for fiberglass insulation based on a combination of three components (1) a polyacid, such as polyacrylic acid, (2) an active hydrogen-containing compound, such as a polyol, or a polyamine, and (3) a cyanamide, a dicyanamide or a cyanoguanidine. In this formulation, an accelerator (catalyst) is said to be optional. Suitable accelerators include a phosphorus or fluoroborate compound.

U.S. Pat. No. 5,977,232 describes a formaldehyde free formulation for fiberglass insulation based on a combination of three components (1) a polyacid, such as polyacrylic acid, (2) an active hydrogen-containing compound, such as a polyol, or a polyamine, and (3) a fluoroborate accelerator.

U.S. Pat. No. 6,114,464 describes a binder for producing shaped articles, such as chipboard, comprising a curable composition of an addition polymer of an unsaturated mono- or dicarboxylic acid and a multi-hydroxyalkylated polyamine.

U.S. Pat. No. 6,171,654 describes preparing fiberglass insulation using a water soluble or water-dispersible curable polyester resin binder formed by reacting a polyol, such as pentaerythritol, a terephthalate polymer, such as recycled polyethylene terephthalate (PET), a polyacid, such as isophthalic and terephthalic acid, an end (mono-functional) acid, a reactive diluent (crosslinker) such as a melamine resin, and an acid catalyst.

U.S. Pat. No. 6,331,350 describes a binder formulation for fiberglass very similar to U.S. Pat. No. 5,661,213 except that the pH of the aqueous solution is adjusted to less than 3.5.

U.S. Pat. No. 6,426,121 describes dual cross-linkable emulsion polymers for use with nonwoven materials. The polymers “incorporate at least two different but reactive functionalities, i.e., hydroxy and carboxy.” The polymer is formed by polymerizing ethylenically unsaturated carboxylic acids in the presence of PVOH. Hydroxyl functionality can be incorporated using hydroxy functional acrylates. The patent does not describe the polymer as self-cross-linking and suggests cross-linking by using a dual crosslinker system of a polyaldehyde and a polyaziridine.

Despite these disclosures, there is a continuing need for identifying new formaldehyde-free, curable aqueous compositions suitable for use as a binder, specifically for fiberglass and especially for making glass fiber products such as fiberglass insulation.

### DETAILED DESCRIPTION OF THE INVENTION

The present invention is directed to a formaldehyde-free binder composition and the related method of its use, such as for making glass fiber insulation products and related products, such as thin fiberglass mats (all hereinafter referred to generically as glass fiber products) and the glass fiber products, especially fiberglass insulation products, made with the cured (crosslinked) adhesive binder.

The present invention particularly relates to an aqueous adhesive binder composition containing a water-soluble and substantially infinitely water-dilutable thermosetting (i.e., thermosettable) adduct (or copolymer) of an unsaturated carboxylic acid monomer (i.e., at least on such monomer) and an unsaturated hydroxyl monomer (i.e., at least one such monomer). The water-soluble adduct is formed by the process of free radical solution polymerization of the two monomers in the presence of a chain transfer agent.

The adhesive binder is applied as a dilute aqueous solution to a mat of glass fibers and is cured by thermal energy, i.e., by heat. Curing (e.g., crosslinking) takes place via an esterification reaction between the pendant carboxyl and hydroxyl groups of the adducts formed by the free radical solution polymerization between the unsaturated carboxylic acid monomer and the unsaturated hydroxyl monomer.

As used herein, “curing,” “cured” and similar terms are intended to embrace the structural and/or morphological change which occurs in the aqueous binder of the present invention as it is dried and heated to cause the properties of a flexible, porous substrate, such as a mat or blanket of glass fibers to which an effective amount of the binder has been applied, to be altered such as, for example, by covalent chemical reaction (crosslinking), ionic interaction or clustering, improved adhesion to the substrate, phase transformation or inversion, and hydrogen bonding.

By “formaldehyde-free” is meant that the composition is substantially free from formaldehyde, and does not liberate substantial formaldehyde as a result of drying and/or curing; typically, less than 1 ppm formaldehyde, based on the weight of the composition, is present in a formaldehyde-free composition. In order to minimize the formaldehyde content of the composition it is preferred to use additives that are themselves free from formaldehyde and do not generate formaldehyde during drying and/or curing.

As used herein, “aqueous” includes water and mixtures composed substantially of water and minor amounts of water-miscible solvents.

As used herein the phrases “glass fiber,” fiberglass” and the like are intended to embrace heat-resistant fibers suitable for withstanding elevated temperatures such as mineral fibers, aramid fibers, ceramic fibers, metal fibers, carbon fibers, polyimide fibers, certain polyester fibers, rayon fibers, and especially glass fibers. Such fibers are substantially unaffected by exposure to temperatures above about 120° C. If intended to embrace predominately and/or only fibers made from glass, i.e., a material made predominately from silica, then a phrase such as “principally glass fiber” or “only glass fiber,” respectively will be used.

As used throughout the specification and claims, the terms mat and blanket are used somewhat interchangeably to embrace a variety of glass fiber substrates of a range of thickness and density, made by entangling short staple fibers, long continuous fibers and mixtures thereof.

As used herein, the term “water soluble” denotes a solubility in an amount of at least about 15 gram(s) per 100 milliliters of water measured at a temperature of 20° C. in deionized water, and preferably about 25 grams. The water-soluble adducts formed by the free radical solution polymerization between an unsaturated carboxylic acid monomer and an unsaturated hydroxyl monomer are soluble in water to the extent of at least about 15 grams per 100 milliliters.

In a first aspect, the present invention is directed to an aqueous binder composition containing as its essential constituent a water-soluble and substantially infinitely water-dilutable, self-curable (i.e., thermosetting or thermosettable) adduct (or copolymer) of an unsaturated carboxylic acid monomer and an unsaturated hydroxyl monomer. The adduct is formed by the free radical solution polymerization between the two monomers in the presence of a chain transfer agent.

In another aspect, the present invention provides a method for binding together a loosely associated mat or blanket of glass fibers comprising (1) contacting said glass fibers with a curable binder composition containing a self-curable adduct as defined above, and (2) heating said curable binder composition at an elevated temperature, which temperature is sufficient to effect cure. Preferably, curing is effected at a temperature broadly within the range from 75° C. to 300° C. usually at a temperature less than about 250° C.

In yet another aspect, the present invention provides a glass fiber product, especially a glass fiber insulation product, comprising a crosslinked (cured) composition obtained by curing a curable binder composition containing a self-curable adduct as defined above, applied to a mat or blanket of nonwoven glass fibers, preferably a mat or blanket of only glass fibers.

In another aspect, the present invention provides a method for using binders of the present invention as a wet strengthening agent for paper and related cellulosic-based products, as well as the resulting wet strengthened paper products.

The water-soluble and substantially infinitely water-dilutable, self-curable (i.e., thermosetting or thermosettable) adduct of an unsaturated carboxylic acid monomer and an unsaturated hydroxyl monomer used in the binder composition of the present invention is prepared by free radical solution polymerization of a monomeric unsaturated carboxylic acid and a monomeric unsaturated hydroxyl component.

As used herein, an “unsaturated carboxylic acid monomer” includes water soluble unsaturated carboxylic acids with a molecular weight of less than about 750, preferably less than 500 and having at least one, and optionally 2 or more, carboxylic acid (—COOH) moieties. If the unsaturated carboxylic acid monomer actually comprises a mixture of molecules with a distribution of molecular weights then for purpose of this definition the molecular weight of the “monomer” is the number average molecular weight of the distribution.

The unsaturated carboxylic acid monomer has at least one —COOH moiety and can be difunctional with respect to the carboxyl group, or higher. The monomeric unsaturated carboxylic acid component may also have other chemical functional groups (such as hydroxyl groups), so long as such groups do not interfere either with the preparation of the adduct by free radical solution polymerization, or with the subsequent cure of the adduct by esterification reactions.

Suitable monomeric unsaturated carboxylic acid components include aconitic acid, itaconic acid, maleic acid, acrylic acid, methacrylic acid (together generally identified as (meth)acrylic acid)), an adduct (ester) of citric acid and maleic acid, crotonic acid, isocrotonic acid, citraconic acid, and fumaric acid. The unsaturated carboxylic acid monomers also include compounds that are capable of presenting carboxylic moieties during the subsequent curing reaction such as maleic anhydride.

An “unsaturated hydroxyl monomer” according to the present invention is a water soluble compound having a molecular weight of less than about 750, preferably less than 500 and having at least one, and optionally 2 or more, hydroxyl (—OH) groups. As with the unsaturated carboxylic acid monomer, if the monomeric unsaturated hydroxyl component actually comprises a mixture of molecules with a distribution of molecular weights then for purpose of this definition the molecular weight is the number average molecular weight of the distribution.

The monomeric unsaturated hydroxyl component has at least one hydroxyl (—OH) moiety and may be difunctional wuth respect to the hydroxyl group, or higher. As with the monomeric unsaturated carboxylic acid, the monomeric unsaturated hydroxyl component may also have other chemical functional groups (such as a carboxyl), so long as such groups do not interfere either with the preparation of the adduct by the free radical solution polymerization, or with the subsequent cure of the adduct by esterification reactions.

Suitable unsaturated hydroxyl monomers include allyl lactate, hydroxyethyl acrylate and hydroxyethyl methacrylate (hereinafter identified together as hydroxyethyl (meth)acrylate), hydroxypropyl (meth)acrylate and the hydroxyalkyl allyl ethers such as 2-allyloxy ethanol and the like. The unsaturated hydroxyl monomer can also include compounds that are capable of presenting hydroxyl moieties during the subsequent curing reaction such as vinyl acetate (vinyl alcohol), glycidyl (meth)acrylate, allyl glycidyl ether, and allyl glycidol.

In preparing the water-soluble and infinitely water dilutable adduct (copolymer), which constitutes the main component, if not the exclusive adhesive component, of the binder composition of the present invention, the monomeric unsaturated carboxylic acid (or a mixture of monomers) and the monomeric unsaturated hydroxyl component (or a mixture of monomers) are reacted by free radical solution polymerization. In order to provide a copolymer with suitable properties, including cure speed, it is important to provide an amount of the unsaturated carboxylic acid monomer in proportion to an amount of the unsaturated hydroxyl monomer so as to maintain a desirable mole ratio of —COOH contributed by the monomeric unsaturated carboxylic acid component to —OH contributed by the monomeric unsaturated hydroxyl component (—COOH:—OH) in the range of about 100:1 to about 1:100, more usually in the range of 10:1 to 1:10, most often in the range of 5:1 to 1:5 and most usually in the range of 2:1 to 1:2. Preferably, this mole ratio of (—COOH:—OH) is in the range of 1.5:1 to 0.7:1.

This mole ratio is conveniently determined by a ratio of the number of moles of the monomeric unsaturated carboxylic acid component multiplied by the average —COOH functionality of the monomeric unsaturated carboxylic acid component to the number of moles of the monomeric unsaturated hydroxyl component multiplied by the average functionality of the monomeric unsaturated hydroxyl component.

The monomeric unsaturated carboxylic acid component and the monomeric unsaturated hydroxyl component are reacted under conditions that are conducive of free radical solution polymerization in an aqueous environment. The free radical solution polymerization of the present invention may be conducted at temperatures broadly in the range of about 25° C. to about 100° C., with a temperature between about 45° to about 90° C. generally being preferred.

The reaction is conducted in the presence of a compound capable of initiating free radical polymerization, i.e., a free radical initiator. Commonly used free radical initiators that can be used in the present invention include the various peroxides, t-butyl hydroperoxide, cumene hydroperoxide, benxoyl peroxide, t-butoxyperoxy hexanoate and various azo compounds such as azodiisobutyronitrile (AIBN), azodiisobutyramidine dihydrochloride (AIBA) and dimethylazodiisobutyrate. Other useful initiators are the water-soluble peroxygen compounds such as hydrogen peroxide and the sodium, potassium and ammonium persulfates used by themselves or in activated redox systems. As well understood by those skilled in the art, the amount of initiator should be sufficient to yield an acceptable reaction rate and, in combination with the level of monomeric reactants and the chain transfer agent, as hereinbelow described, an adduct of a suitable molecular weight to be water soluble. The amount of initiator, however, should not be so high as to result in an uncontrolled rate of reaction and possible gel formation. The amount of initiator used in the solution polymerization will generally be in the range of 0.01 to 3% by weight, based on the weight of the monomers, and is usually between about 0.2 and 2% by weight. The initiator can be charged at the outset of the polymerization, however, incremental addition of the initiator throughout polymerization can also be employed and may be advantageous in some circumstances.

Another important constituent of the reaction system is the chain transfer agent. As understood by those skilled in the art, the chain transfer agent functions to limit or control the molecular weight of the polymeric adduct formed by the free radical polymerization reaction taking place between the monomeric reactants. Thus, the chain transfer agent is used in an amount sufficient to limit the molecular weight of the free radical polymerization adduct so that the resulting adduct is water-soluble. In addition, it is preferred that the chain transfer agent be used in an amount such that the molecular weight of the resulting adduct is sufficiently low that aqueous solutions of the adduct, at high solids concentrations, have a viscosity low enough to permit use of the binder, such as to provide good wetting of the glass fibers by the adhesive binder composition. The amount of the chain transfer agent should not be so high, however, that it so severely limits the molecular weight of the resulting adduct that the subsequently cured polymer has poor mechanical properties (strength). In order to accomplish these objectives, the chain transfer agent will generally be included in the reaction mixture in the range of about 0.1 to 30% by weight, based on the weight of the monomers, and most often will be used in an amount between about 0.5 and 15% by weight. The determination of a suitable level of chain transfer agent to use in any monomer system is a matter of routine experimentation to those of ordinary skill in the art.

The chain transfer agent usually is charged into the reaction mixture at the outset of the polymerization, though it too may be added later in the reaction or in increments if desired. Any material that is able to control/limit the extent of the polymerization between the unsaturated carboxylic acid monomer and the unsaturated hydroxyl monomer via chain transfer can be used as the chain transfer agent. Suitable chain transfer agents include allyloxypropane diol, thioglycol, mercaptans such as dodecylmercaptan and adducts of rosin and fumaric acid or maleic acid (maleic anhydride). Such adducts can be prepared by heating rosin in the presence of the fumaric or the maleic reactants at an appropriate temperature and for an appropriate time. In the case of fumaric and maleic acids, the reaction mixture can be heated to a temperature of about 200° to 220° C. and held for about 2 hours. When reacting rosin with maleic anhydride, the reaction temperature is usually about 160° to 170° C. and the hold time is about 4 hours. See U.S. Pat. No. 2,628,918, incorporated herein by reference. Usually the rosin comprises about 80-94% of the reactants. Upon cooling the adduct, one typically obtains a brittle solid. By using the chain transfer agent, one is able to limit the molecular weight and preserve the water solubility and infinite water dilutability of the resulting free radical polymerization copolymer adduct.

As understood by those skilled in the art, free radical solution polymerization reactions can be conducted by charging a reactor with appropriate amounts of the unsaturated carboxylic acid monomer, the chain transfer agent and the free radical initiator. An amount of water (and an optional water miscible solvent) also is included in the reactor (and additional water can optionally be added with the later added unsaturated hydroxyl monomer as well) to provide a final adduct concentration in the aqueous composition within the range of about 5 to about 50 weight percent. Following heating to a free radical polymerization initiation temperature, the unsaturated hydroxyl monomer then is slowly added to the reaction mixture, in a controlled manner, usually promptly after the addition of the free radical initiator into the reactor. The rate of monomer addition can be varied depending on the polymerization temperature, the particular initiator employed and the amount of the monomer(s) being polymerized. The rate of polymerization also can be controlled by metering the free radical initiator into the reactor, rather than adding it all at the start of the reaction.

After all the components have been charged, the reaction is run for a length of time necessary to achieve the desired conversion. The reaction conditions should be adjusted as needed to maintain proper solution polymerization conditions and to ensure that a water-soluble polymer is obtained. Such adjustments are well within the skill of the art and are routine to those skilled in the art. The pH of the adduct solution following the polymerization can broadly be in the range of 2 to 100 and is often in the range of about 2 to about 6. The extent of the reaction can be monitored simply by examining samples of the reaction mixture for their non-volatile solids content. As the volatile reactant components get incorporated into the polymerization adducts (copolymers), the non-volatile solids content of the reaction mixture increases. A suitable end-point is when the non-volatile solids content stabilizes to a value essentially equal to the total mass of the added monomers, chain transfer agent and initiator.

It is also possible to include a less-water soluble, unsaturated monomer (or monomers) (hydrophobic comonomer(s)), such as styrene, alpha-methyl-styrene, acrylonitrile, methyl (meth)acrylate, vinyl acetate, ethyl (meth)acrylate and the like, in the reaction mixture so long as the addition does not interfere with the preparation of a water-soluble adduct that when cured exhibits acceptable performance in the glass fiber product. Except in circumstances discussed herebelow, the optional hydrophobic comonomer generally should be present in the reaction mixture in an amount of less about 20% by weight, and preferably in an amount less than 15% by weight, of the combined amounts of the unsaturated carboxylic acid monomers and the unsaturated hydroxyl monomers.

It may also be desirable to include an ethylenically unsaturated monomer, that is either cationic or anionic in nature, to be co polymerized with the above-mentioned monomers. Such cationic or anionic monomers may also contain another reactive functional group or groups such as hydroxyl or carboxylic groups, as long as they do not interfere with the free radical polymerization, which results in the formaldehyde free binder of this invention. The presence of such functional groups then can be made to under go crosslinking under curing conditions. In this alternative embodiment, it may also is possible to increase the amount of hydrophobic comonomer content in the reaction mixture up to about 40%, such as in the range of 30 to 40%, for example, and still obtain a water-soluble adduct. Examples of anionic comonomers are, for example, sodium para-styrene sulfonic acid and allyloxy propanediol sodium sulfonate. Examples of cationic unsaturated monomers are acrylamido-3-propanetrimethyl ammonium chloride and methacryloyloxyethyl trimethyl ammonium chloride. The presence of these anionic or cationic unsaturated comonomers in the reaction mixture helps to solubilize the otherwise less water-soluble monomers discussed above. The amount of these optional cationic or anionic ethylenically unsaturated monomers can range between 0 to 30%, and more usually between 0 and 20% by weight of the combined amounts of the unsaturated carboxylic acid monomers and the unsaturated hydroxyl monomers.

The resulting water soluble and infinitely water dilutable copolymer adduct made by the free radical polymerization reaction, as described above, can be produced and used under a broad range of pH conditions. A pH in the range of 2 to 11 has been shown to be suitable. The adduct can be used directly as a binder or may be blended with other known ingredients such as curing agents (catalysts), fillers, antioxidants or stabilizers, antifoaming agents, pigments, or other conventional ingredients. Furthermore, thickeners or bodying agents may be added to the adduct solution so as to control its viscosity and thereby achieve the proper flow properties for a particular application.

Suitable catalysts that optionally can be used in the binder composition for promoting the esterification reaction, i.e., the crosslinking reaction, between the carboxylic (—COOH) moieties and the hydroxyl (—OH) moieties of the free radical polymerized adducts include inorganic acids, such as sulfuric acid, lead acetate, sodium acetate, calcium acetate, zinc acetate, organotin compounds, titanium esters, antimony trioxide, germanium salts, ammonium chloride, sodium hypophosphite, sodium phosphite and organic acids such as methane sulfonic acid and para toluene sulfonic acid. The phosphorus accelerators (catalysts) described in U.S. Pat. No. 5,661,213 can also be employed. Other catalysts that could be used will be apparent to those skilled in the art and the present invention is not limited to any particular catalyst composition. The catalyst would generally be used in an amount of 10 wt. % or less, more usually 0.01 to 10 wt. %, even more typically 0.1 wt. % to 5 wt. %, and most often 0.5 wt. % to 2 wt. %, based on the weight of the adduct.

It also may be desirable in some instances to include some amount (generally a small amount) of an additional crosslinking agent in the binder. Such crosslinking agents may comprise a saturated hydroxy-acid, a polyol, a polycarboxylic acid, a polyamine, a polyamide, a polyaminoamide, or a polyester. These materials provide additional opportunity for crosslink formation and may enhance the performance of the binder. Materials such as glycolic acid, tartaric acid, lactic acid and citric acid function as multi-functional reactants in the polyester curing reaction and also can self polymerize. As polycarboxylic acids can be mentioned a styrene-maleic acid (anhydride) copolymer, polyacrylic acid, and a rosin-fumaric, or a rosin-maleic acid adduct. Polyamines include ethylene diamine and diethylenetriamine. Exemplary polyols include ethylene glycol, diethylene glycol, triethylene glycol, ethylene oxide, polyethyleneoxide (hydroxy terminated), glycerol, pentaerythritol, trimethylol propane, sorbitol, sucrose, glucose, polyvinyl alcohols, resorcinol, catechol, pyrogallol, glycollated ureas, 1,4-cyclohexane diol, amino alcohols such as diethanolamine, and triethanolamine. Polyamimoamides are well known from their use as a building block of wet-strengthening agents, and contain reactive hydrogens (i.e., primary and secondary amine groups) that form amide linkages with the carboxyl groups in the copolymer. Through the process of transesterification, a polyester can also contribute to crosslink formation with the hydroxyl and carboxyl groups of the copolymer.

The aqueous adduct solution can be easily blended with such other ingredients and diluted to a low concentration which is readily sprayed onto the glass fibers as they fall onto a collecting conveyor as described in more detail hereafter.

In operation, the binder of the present invention is formulated into a dilute aqueous solution and then is usually applied to glass fibers as they are being produced and formed into a mat or blanket. Water is volatilized from the binder as it is applied onto the hot glass fibers, and the high-solids binder-coated fibrous glass mat then is heated to cure the binder and thereby produce a finished glass fiber product, e.g., fiberglass insulation product. The binder composition is generally applied in an amount such that the cured binder constitutes about 5 wt. % to about 15 wt. % of the finished glass fiber product, e.g., fiberglass insulation product, although it can be as little as 1 wt. % or less and as high as 20 wt. % or more, depending upon the type of glass fiber product. Optimally, the amount of binder for most thermal insulation products will be the amount necessary to lock the fibers into an integral mass by bonding the fibers where they cross or overlap. For this reason, it is desired to have binder compositions with good flow characteristics, so that the binder solution can be applied to the fiber at a low volume that will flow to the fiber intersections.

To prepare an adhesive binder formulation, it may also be advantageous to add a silane coupling agent (e.g., organo silicon oil) to the adduct solution in an amount of at least about 0.05 wt. % based on the weight of binder solids. Suitable silane coupling agents (organo silicon oils and fluids) have been marketed by the Dow-Corning Corporation, Petrarch Systems, and by the General Electric Company. Their formulation and manufacture are well known such that detailed description thereof need not be given. When employed in the binder composition of this invention, the silane coupling agents typically are present in an amount within the range of about 0.1 to about 2.0 percent by weight based upon the binder solids and preferably in an amount within the range of 0.1 to 0.5 percent by weight. Representative silane coupling agents are the organo silicon oils marketed by Dow-Corning Corporation; A0700, A0750 and A0800 marketed by Petrarch Systems and A 1100 (an amino propyl, trimethoxy silane) or A1160 marketed by Dow Chemical Corporation. This invention is not directed to and thus is not limited to the use of any particular silane additives.

The binder may be prepared by combining the water-soluble adduct and the silane coupling agent in a relatively easy mixing procedure carried out at ambient temperatures. The binder can be used immediately and may be diluted with water to a concentration suitable for the desired method of application, such as by spraying onto the glass fibers.

The particular method for forming glass fibers for use in the present invention is relatively unimportant. Processes for making glass fiber products, and especially fiberglass insulation products using a binder resin of the present invention are typically carried out according to one of a number of methods wherein a molten mineral material flowing from a melting furnace is divided into streams and attenuated into fibers. The attenuation can be done by centrifuging and/or fluid jets to form discontinuous fibers of relatively small dimensions which typically are collected by randomly depositing on a moving foraminous (porous) conveyor belt. The fibers are collected in a felted haphazard manner to form a mat. The volume of fiber in the mat will be determined by the speed of fiber formation and the speed of the belt.

Continuous glass fibers also may be employed in the form of mats or blankets fabricated by swirling the endless filaments or strands of continuous fibers, or they may be chopped or cut to shorter lengths for mat or batt formation. Use can also be made of ultra-fine fibers formed by the attenuation of glass rods. Also, such fibers may be treated with a size, anchoring agent or other modifying agent before use.

Glass fiber insulation products may also contain fibers that are not in themselves heat-resistant such as, for example, certain polyester fibers, rayon fibers, nylon fibers, and superabsorbent fibers, in so far as they do not materially adversely affect the performance of the glass fiber product.

In order to produce most glass fiber products and especially fiberglass thermal insulation products, the fibers must be bonded together in an integral structure. To achieve this binding, the curable binder composition of the present invention is applied to the glass fiber mat or blanket. When making fiberglass insulation, the layer of fiber with binder is then mildly compressed and shaped into the form and dimensions of the desired thermal insulation product. The insulation product then is passed through a curing oven where the binder is cured fixing the size and shape of the finished insulation product. In addition to radiant curing ovens, radio frequency and microwave heaters can also be mentioned.

The binder composition may be applied to the fiberglass by conventional techniques such as, for example, air or airless spraying, padding, saturating, roll coating, curtain coating, beater deposition, and coagulation. For example, the binder can be applied to the glass fibers by flooding the collected mat of glass fibers and draining off the excess, by applying the binder composition onto the glass fibers during mat or blanket formation, by spraying the glass fiber mat or the like. As noted above, the layer of fiber with binder can then be mildly compressed and shaped into the form and dimensions of the desired insulation product such as pipe, batt or board and passed through a curing oven where the binder is cured, thus fixing the size and shape of the finished insulating product by bonding the mass of fibers one to another and forming an integral composite structure.

The aqueous binder composition, after it is applied to the glass fiber, is heated to effect drying and curing. The duration and temperature of heating will affect the rate of drying, processability and handleability, degree of curing and property development of the treated substrate. The curing temperatures are within the range from 50 to 300° C., preferably within the range from 90 to 230° C. and the curing time will usually be somewhere between 3 seconds to about 15 minutes.

On heating, water present in the binder composition evaporates, and the composition undergoes curing. These processes can take place in succession or simultaneously. Curing in the present context is to be understood as meaning the chemical alteration of the composition, for example crosslinking through formation to covalent bonds between the various constituents of the composition, especially the esterification reaction between pendant carboxyl (—COOH) and hydroxyl (—OH) moieties of the water-soluble adducts, the formation of ionic interactions and clusters, and formation of hydrogen bonds.

As noted, the drying and curing functions may be effected in two or more distinct steps, if desired. For example, the composition may be first heated at a temperature and for a time sufficient to substantially dry but not to substantially cure the binder composition and then heated for a second time at a higher temperature and/or for a longer period of time to effect curing (thermosetting). Such a preliminary procedure, referred to as “B-staging”, may be used to provide binder-treated product, for example, in roll form, which may at a later stage be cured, with or without forming or molding into a particular configuration, concurrent with the curing process. This makes it possible, for example, to use the compositions of this invention for producing binder-impregnated semifabricates which can be molded and cured elsewhere.

The glass fiber component will represent the principal material of the glass fiber products, such as a fiberglass insulation product. Usually 99-60 percent by weight of the product will be composed of the glass fibers, while the amount of binder solids will broadly be in reverse proportion ranging from 1-40 percent, depending upon the density and character of the product. Glass insulations having a density less than one pound per cubic foot may be formed with binders present in the lower range of concentrations while molded or compressed products having a density as high as 30-40 pounds per cubic foot can be fabricated of systems embodying the binder composition in the higher proportion of the described range.

Glass fiber products can be formed as a relatively thin product, such as a mat having a thickness of about 10 to 50 mils; or they can be formed as a relatively thick product, such as a blanket of 12 to 14 inches or more. Glass fiber products of any thickness are embraced by the present invention. The time and temperature for cure for any particular glass fiber product will depend in part on the amount of binder in the final structure and the thickness and density of the structure that is formed and can be determined by one skilled in the art using only routine testing. For a structure having a thickness ranging from 10 mils to 1.5 inch, a cure time ranging from several seconds to 1-5 minutes usually will be sufficient at a cure temperature within the range of 175°-300° C.

Glass fiber products may be used for applications such as, for example, insulation batts or rolls, as reinforcing mat for roofing or flooring applications, as roving, as microglass-based substrate for printed circuit boards or battery separators, as filter stock, as tape stock, and as reinforcement scrim in cementitious and non-cementifious coatings for masonry.

It also has been shown that binders of the present invention, particularly when modified with a cationic moiety, such as a binder prepared by co-polymerizing maleic acid, hydroxyethyl acrylate and methacryloyloxyethyl trimethyl ammonium chloride, are useful as wet strengthening agents for cellulosic-based products, e.g., paper.

It will be understood that while the invention has been described in conjunction with specific embodiments thereof, the foregoing description and following examples are intended to illustrate, but not limit the scope of the invention. Other aspects, advantages and modifications will be apparent to those skilled in the art to which the invention pertains, and these aspects and modifications are within the scope of the invention.

### EXAMPLE 1

A polymer suitable for preparing a binder of the present invention can be prepared as follows. Water (1400 parts by weight) and maleic anhydride (MA)(unsaturated carboxylic acid) (270 parts by weight) are added to a reactor kettle equipped with reflux (for cooling), a heater, a thermometer, nitrogen inlet, temperature controller probe, an overhead stirrer for mixing and a pressure equalized addition funnel. Water is first added and nitrogen gas is bubbled through it. Following the addition of the MA The contents of the reactor are heated to a temperature of about 72° C. and held for about 30 minutes to insure the dissolution of the maleic anhydride and make sure it is completely converted to maleic acid. A free radical initiator (AIBN) in an amount of 2.5 parts by weight is added followed by the chain transfer agent, allyloxy-1,2-propane diol (45 parts by weight). Immediately, a programmed dropwise addition of hydroxyethyl acrylate (HEA) (unsaturated hydroxyl monomer) is initiated while maintaining a temperature of about 72° C. The HEA (313 parts by weight), diluted with 100 parts additional water, is added over a period of at least ninety (90) minutes. The progress of the reaction can be monitored by measuring the total non-volatile solids. Once the expected non-volatile solids content is reached (˜30 weight percent in this case), 100% conversion is achieved. The reaction can be terminated by cooling the reaction mixture to room temperature. The copolymer solution exhibited a pH of about 0.9-1.0.

### EXAMPLE 1A

The synthesis reaction was repeated substantially as described in Example 1, except that the pH of the final product was increased from 0.9-1.0 to the range of 4.5-5.5 using aqueous ammonia. The final solids content of the solution also was adjusted to be in the range 29-31%.

### EXAMPLE 1B

Another synthesis reaction was repeated substantially as described in Example 1, except that the pH of the reaction mixture was adjusted with aqueous ammonia to the range of 4.5-5.0 before the addition of the AIBN initiator and the programmed addition of the hydroxyethyl acrylate. The resulting copolymer solution exhibited a pH of about 5.16.

### EXAMPLE 2

Another polymer suitable for preparing a binder of the present invention can be prepared as follows. Water (400 parts by weight), itaconic acid (IA)(unsaturated carboxylic acid) (58.3 parts by weight), allyloxy-1,2-propane diol (chain transfer agent) (15.9 parts by weight) and a free radical initiator (AIBN) (0.7 parts by weight) are added to a reactor kettle in a manner akin to Example 1. Then, the programmed, dropwise addition of hydroxyethyl acrylate (HEA) (unsaturated hydroxyl monomer) is initiated. The HEA (92.8 parts by weight), diluted with 30 parts additional water, can be added over a period of at least sixty (60) minutes while maintaining the temperature of the agitated aqueous mixture at about 72° C. Again, the reaction can be quenched by cooling to room temperature. Normally the reaction is monitored by measuring the non-volatile solids contents of the reaction mixture. As the polymerization occurs, the non-volatile solids content will increase and eventually levels off when the expected solids content is reached. At this point, the reaction is considered completed.

### EXAMPLE 3

A glass fiber binder can be prepared using the adducts of Examples 1, 1A and 11B as follows: 265 grams of the free radical polymerized adduct of Example 1 (or 1A or 1B) is mixed with 133.7 grams of water to prepare a binder containing 20 weight percent solids. The ingredients can be added to a ½ gallon jar and mixed well.

### EXAMPLE 4

An adhesive binder formulation was prepared using the adduct of Example 2 as follows: 279.3 grams of the free radical polymerized adduct of Example 2 is mixed with 107.6 grams of water to prepare a binder containing 20 weight percent solids. The ingredients can be added to a ½ gallon jar and mixed well.

### EXAMPLE 5

Wet tensile strengths of hand sheets prepared using curable aqueous binder compositions of the type prepared in accordance with Examples 3 (3A and 3B) and 4 were examined. Hand sheets were prepared by sprinkling the binder onto a glass mat, formed from ½ inch PPG M-8035 chopped glass fibers dispersed in water containing a polyacrylamide, vacuuming the excess binder off the glass fibers and then curing the sheet in an oven at 200 to 240° C. for 1 to 5 minutes.

Hot/wet tensile strength of mats prepared using the binder of the type prepared in Examples 3 (3A and 3B) and 4 were then measured by soaking the handsheets in 185° F. (85° C.) water for 10 minutes. Samples of the hand sheets (3 inches by 5 inches) were then subjected to breaking a tensile tester (QC-1000 Materials Tester by the Thwing Albert Instrument Co.) while they were still hot and wet. The hand sheet made from the binder of the type of Example 3 exhibited a hot/wet tensile strength of 31.7 pounds; the hand sheet made from the binder of the type of Example 3A exhibited a hot/wet tensile strength of 33 pounds; the hand sheet made from the binder of the type of Example 3B exhibited a hot/wet tensile strength of 32.8 pounds; while the hand sheet made using the binder of the type of Example 4 exhibited a hot/wet tensile of 36 pounds. A typical PF resin binder exhibits a hot/wet tensile of about 35 pounds.

### EXAMPLE 6

Another polymer suitable for preparing a binder of the present invention can be prepared as follows. A reaction kettle is equipped with an overhead stirrer, thermometer, nitrogen inlet, temperature controller probe and a pressure equalized addition funnel. Water (395 parts by weight) is first added to the kettle and nitrogen gas is bubbled through it. Maleic anhydride (MA) (an unsaturated carboxylic acid) (60 parts by weight) is added to it. The kettle is warmed to 72° C. and held for 30 minutes to make sure the maleic anhydride is converted to maleic acid. Free radical initiator AIBN (1.00 part) is added to the reaction solution, followed by the chain transfer agent, mercaptoethanol (0.30 parts). Then, the programmed, dropwise addition of a mixture of hydroxyethyl acrylate (HEA) (unsaturated hydroxyl monomer) and vinyl acetate (hydrophobic comonomer) is immediately initiated while maintaining the temperature at 72° C. The mixture of HEA (58.3 parts by weight) and vinyl acetate (20.0 parts by weight) can be added over a period of at least sixty (60) minutes while maintaining the temperature of the agitated aqueous mixture at about 72° C. Again, the reaction mixture can be quenched by cooling it to room temperature. The progress of the reaction can be monitored by measuring the non-volatile solids contents of the reaction mixture. Once the expected solids content is reached, 100% conversion is achieved. The reaction can be stopped by cooling the reaction to room temperature when the resin solution reaches the expected solids content (˜30% in this case). At this point, the reaction is considered completed.

### EXAMPLE 6A

The synthesis of Example 6 can be repeated using instead a mixture of HEA (42.4 parts by weight) and vinyl acetate (30.6 parts by weight).

### EXAMPLE 7

A glass fiber binder can be prepared using the adducts of Examples 6 and 6A in accordance with Example 3 and hot/wet tensile strengths of mats prepared using the binder and determined as described in Example 5. A hand sheet made from the binder of the type of Example 6 exhibits a hot/wet tensile strength of 18 pounds; while a hand sheet made using the binder of the type of Example 6A exhibits a hot/wet tensile of 19 pounds.

### EXAMPLE 8

Water (1000 parts by weight) is added to a reaction kettle equipped with reflux (for cooling), a heater, a thermometer, nitrogen inlet, temperature controller probe, an overhead stirrer for mixing and a pressure equalized addition funnel. Maleic acid (an unsaturated carboxylic acid) (282 parts by weight) is then added. After the dissolution of maleic acid, isopropyl alcohol (1150 parts) is added, followed by the addition of styrene (hydrophobic monomer) (282 parts) and sodium para-styrene sulfonic acid, SPSS, (anionic monomer) (50 parts). The mixture is heated to 82° C. A three and a half hour programmed addition of the initiator ammonium persulfate (35 parts by weight) in 350 parts by weight of water is started. About 2 hours into the addition, the programmed drop wise addition of hydroxyethyl acrylate (HEA) is initiated while maintaining a temperature of about 82° C. The HEA (375 parts by weight) is added over a period of at least ninety (90) minutes. The progress of the reaction can be monitored by measuring the total non-volatile solids. Once the expected non-volatile solids content is reached (˜30 weight percent in this case), 100% conversion is achieved. The isopropyl alcohol is removed by distillation with a simultaneous addition of ammonium hydroxide and water to keep the polymer in solution. The addition of water and aqueous ammonia are adjusted such that the final solids content is about 30% and the pH is in the range of 7.5-8.5.

### EXAMPLE 8A

The synthesis of Example 8 can be substantially repeated except that the addition of the sodium para-sulfonic acid is eliminated.

### EXAMPLE 9

A glass fiber binder can be prepared using the adducts of Examples 8 and 8A in accordance with Example 3 and hot/wet tensile strengths of mats prepared using the binder and determined as described in Example 5. A hand sheet made from the binder of the type of Example 8 (at 20% binder solids) exhibits a hot/wet tensile strength of 39 pounds; while a hand sheet made using the binder of the type of Example 8A (at 20% binder solids) exhibits a hot/wet tensile of 40 pounds.

### EXAMPLE 10

Water (200 parts by weight) is added to a reaction kettle equipped with reflux (for cooling), a heater, a thermometer, nitrogen inlet, temperature controller probe, an overhead stirrer for mixing and a pressure equalized addition funnel. Maleic acid (an unsaturated carboxylic acid) (95.17 parts by weight) is then added. After the dissolution of maleic acid, isopropyl alcohol (328 parts) is added, followed by the addition of styrene (hydrophobic monomer) (76 parts), sodium para-styrene sulfonic acid, SPSS, (anionic monomer) (16.4 parts), and hydroxyethyl acrylate (20 parts). The mixture is heated to 76° C. Then, a five (5) hour programmed addition of the initiator ammonium persulfate (5.7 parts by weight) dissolved in 35 parts by weight of water is started. The progress of the reaction can be monitored by measuring the total non-volatile solids. Once the expected non-volatile solids content is reached (˜26 weight percent in this case), 100% conversion is achieved. The isopropyl alcohol is removed by distillation with a simultaneous addition of dilute aqueous ammonium hydroxide to keep the polymer in solution. The addition of aqueous ammonia (and water if required) are adjusted such that the final solids content is about 30% and the pH is in the range of 7.5-8.5.

### EXAMPLE 11

A glass fiber binder can be prepared using the adduct of Example 10 in accordance with Example 3 and hot/wet tensile strengths of mats prepared using the binder and determined as described in Example 5. A hand sheet made from the binder of the type of Example 10 (at 20% binder solids) exhibits a hot/wet tensile strength of about 25.2 pounds

### EXAMPLE 12

Water (182 parts by weight) is added to a reaction kettle equipped with reflux (for cooling), a heater, a thermometer, nitrogen inlet, temperature controller probe, an overhead stirrer for mixing and a pressure equalized addition funnel. Maleic acid (an unsaturated carboxylic acid) (70.4 parts by weight) is then added. After the dissolution of maleic acid, isopropyl alcohol (272.4 parts) is added, followed by the addition of styrene (hydrophobic monomer) (54.49 parts), sodium para-styrene sulfonic acid, SPSS, (anionic monomer) (8.38 parts) and an adduct of rosin and fumaric acid (4.19 parts) as a chain transfer agent. The mixture is heated to 82° C. A three and a half hour programmed addition of the initiator ammonium persulfate (4.25 parts by weight) in 37.7 parts by weight of water is started. About 2 hours into the addition, the programmed drop wise addition of hydroxyethyl acrylate (HEA) is initiated while maintaining a temperature of about 82° C. The HEA (56.58 parts by weight) is added over a period of at least ninety (90) minutes. The progress of the reaction can be monitored by measuring the total non-volatile solids. Once the expected non-volatile solids content is reached (˜30 weight percent in this case), 100% conversion is achieved. The isopropyl alcohol is removed by distillation with a simultaneous addition of ammonium hydroxide and water to keep the polymer in solution. The addition of water and aqueous ammonia are adjusted such that the final solids content is about 30% and the pH is in the range of 7.5-8.5.

### EXAMPLE 13

A glass fiber binder can be prepared using the adduct of Example 12 in accordance with Example 3 and hot/wet tensile strengths of mats prepared using the binder and determined as described in Example S. A hand sheet made from the binder of the type of Example 12 (at 20% binder solids) exhibits a hot/wet tensile strength of about 34 pounds.

The present invention has been described with reference to specific embodiments. However, this application is intended to cover those changes and substitutions that may be made by those skilled in the art without departing from the spirit and the scope of the invention. Unless otherwise specifically indicated, all percentages are by weight. Throughout the specification and in the claims the term “about” is intended to encompass + or −5%.

1. A water soluble adduct resulting from free radical solution polymerization of an unsaturated carboxylic acid monomer and an unsaturated hydroxyl monomer, the polymerization conducted in the presence of a chain transfer agent.

2. The water soluble adduct of claim 1 wherein the unsaturated carboxylic acid monomer has a molecular weight of less than 500 and has 2 or more carboxylic acid (—COOH) moieties.

3. The water soluble adduct of claim 2 wherein the unsaturated carboxylic acid monomer is selected from aconitic acid, itaconic acid, maleic acid, acrylic acid, methacrylic acid, an adduct of citric acid and maleic acid, crotonic acid, isocrotonic acid, citraconic acid, and maleic anhydride.

4. The water soluble adduct of claim 1 wherein the unsaturated hydroxyl monomer has a molecular weight of less than 500 and has 2 or more, hydroxyl (—OH) groups.

5. The water soluble adduct of claim 4 wherein the unsaturated hydroxyl monomer is selected from allyl lactate, hydroxyethyl acrylate, hydroxyethyl methacrylate, hydroxypropyl acrylate hydroxypropyl methacrylate, 2-allyloxy ethanol, vinyl acetate, glycidyl acrylate, glycidyl methacrylate, allyl glycidyl ether, and allyl glycidol.

6. The water soluble adduct of claim 1 wherein the unsaturated carboxylic acid monomer and the unsaturated hydroxyl monomer are provided in an amount to maintain a mole ratio of —COOH contributed by the monomeric unsaturated carboxylic acid component to —OH contributed by the monomeric unsaturated hydroxyl component (—COOH:—OH) in the range of about 10:1 to 1:10.

7. The water soluble adduct of claim 6 wherein the mole ratio is in the range of 1.5:1 to 0.7:1.

8. The water soluble adduct of claim 1 wherein the chain transfer agents is selected from allyloxypropane diol, thioglycol, mercaptans, an adduct of rosin and maleic acid, an adduct of rosin and fumaric acid and an adduct or rosin and maleic anhydride.

9. The water soluble adduct of claim 1 wherein the free radical solution polymerization also is conducted in the presence of an anionic or cationic ethylenically unsaturated monomer.

10. The water soluble adduct of claim 1 or 9 wherein the free radical solution polymerization also is conducted in the presence of a hydrophobic comonomer.

11. The water soluble adduct of claim 9 wherein the anionic comonomer is selected from sodium para-styrene sulfonic acid and allyloxy propanediol sodium sulfonate.

12. The water soluble adduct of claim 9 wherein the cationic unsaturated monomer is selected from acrylamido-3-propanetrimethyl ammonium chloride and methacryloyloxyethyl trimethyl ammonium chloride.

13. An aqueous binder composition for making glass fiber products comprising the water soluble adduct of claim 1.

14. An aqueous binder composition for making glass fiber products comprising the water soluble adduct of claim 2.

15. An aqueous binder composition for making glass fiber products comprising the water soluble adduct of claim 4.

16. An aqueous binder composition for making glass fiber products comprising the water soluble adduct of claim 7.

17. An aqueous binder composition for making glass fiber products comprising the water soluble adduct of claim 9.

18. An aqueous binder composition for making glass fiber products comprising the water soluble adduct of claim 10.

19. An aqueous binder composition of claims 13, 14, 15, 16, 17, or 18 also comprising a crosslinking agent selected from the group consisting of a saturated hydroxy-acid, a polyol, a polycarboxylic acid, a polyamine, a polyamide, a polyaminoamide, and a polyester.

20. A method for binding together a loosely associated mat of glass fibers comprising (1) contacting said glass fibers with the aqueous binder composition of one of claims 13, 14, 15, 16, 17 or 18 and (2) heating said aqueous binder composition at an elevated temperature sufficient to effect cure.

21. A method for binding together a loosely associated mat of glass fibers comprising (1) contacting said glass fibers with the aqueous binder composition of claim 19 and (2) heating said aqueous binder composition at an elevated temperature sufficient to effect cure.

22. A glass fiber product obtained by curing the aqueous binder composition of one of claims 13, 14, 15, 16, 17 or 18 applied to a mat of nonwoven glass fibers.

23. A glass fiber product obtained by curing the aqueous binder composition of claim 19 applied to a mat of nonwoven glass fibers.

24. The glass fiber product of claim 22 wherein the glass fiber product is a fiberglass insulation product.

25. The glass fiber product of claim 23 wherein the glass fiber product is a fiberglass insulation product.

26. A method for increasing wet strength of paper comprising (1) contacting said paper with an aqueous binder composition containing the water soluble adduct of claim 12 and (2) heating said aqueous binder composition at an elevated temperature sufficient to effect cure.
